(19) United States
(12) Patent Application Publication
(10) Pub. No.: US 2021/0114765 A1
(43) Pub. Date: Apr. 22, 2021

(54) METHOD FOR PRODUCING A BLANK FOR A PACKAGING ITEM, BLANK AND PACKAGING MADE FROM A BLANK

(71) Applicant: MAYR-MELNHOF KARTON AG, Wien (AT)

(72) Inventors: Jürgen KOLLMANN, Pölich (DE); Harman VORENKAMP, Auenwald (US); Uwe THEIS, Riveris (DE)

(21) Appl. No.: 16/338,968

(22) PCT Filed: Oct. 5, 2017
(86) PCT No.: PCT/EP2017/075329

§ 371 Date: Apr. 2, 2019

(30) Foreign Application Priority Data
Oct. 5, 2016 (DE) 10 2016 118 895.6

(51) Int. Cl. B65D 5/42; B65D 5/02

(52) U.S. Cl. CPC B65D 5/4266; B31B 50/25; B65D 5/0254; B65D 5/029

(57) ABSTRACT

The invention relates to a method for producing a blank for a packaging item having a cellulose-containing base material with at least one line from the group of folding, crease, cutting, scored and/or bending lines, wherein the at least one line is defined at least in sections by the application of water and/or of at least one hygroscopic substance to the base material. The invention also relates to a blank for producing a packaging item including a cellulose-containing base material having at least one line from the group of folding, crease, cutting, scored and/or bending lines, wherein the at least one line is defined at least in sections by water and/or by at least one hygroscopic substance applied to the base material. The invention further relates to a method for producing a packaging item from a blank of this type, and to a corresponding packaging item for storing goods.

The invention relates to a method for producing a blank for a packaging item including a cellulose-containing base material with at least one line from the group of the folding, crease, cutting, scored and/or bending lines. Furthermore, the invention relates to a blank for producing a packaging item including a cellulose-containing base material with at least one line from the group of the folding, crease, cutting, scored and/or bending lines, to a method for producing a packaging item from such a blank as well as to a packaging item produced from such a blank.

Cellulose-based packaging items at least partially composed of paper, cardboard or paperboard are known in a great plurality. In particular, such packaging items are used for filling, the transport and the storage of different goods. Therein, the goods can for example be cereals, cornflakes or other pourable and free-flowing foods. Similarly, packaging items for rod-shaped goods like cigarettes, cigars and the like are known. The production of such packaging items is effected using blanks, which are provided with one or more lines from the group of the folding, crease, cutting, scored and/or bending lines and subsequently correspondingly folded, creased, cut, scored and/or bent along these lines. The definition of these lines is usually effected via various techniques such as for example stamping, punching, embossing, debossing, scoring, laser cutting and the like.

The circumstance is to be regarded as disadvantageous that the definition and production, respectively, of such lines is associated with a relatively high effort in terms of equipment and is only hardly adaptable to differently formed base materials or packaging variants.

It is the object of the present invention to specify a method for producing a blank for a packaging item, by which at least one line from the group of the folding, crease, cutting, scored and/or bending lines can be more flexibly defined on or in a cellulose-containing base material. A further object of the invention is in specifying a blank for producing a packaging item, which includes a cellulose-containing base material with at least one line from the group of the folding, crease, cutting, scored and/or bending lines, wherein the at least one line can be more flexibly defined. A further object of the invention is in specifying a method for producing a packaging item from such a blank as well as a packaging item produced from such a blank.

According to the invention, the objects are solved by a method according to claim 1 for producing a blank for a packaging item, by a blank according to claim 13 for producing a packaging item, by a method according to claim 15 for producing a packaging item from such a blank as well as by a packaging item according to claim 19. Advantageous configurations with convenient developments of the invention are specified in the respective dependent claims, wherein advantageous configurations of each inventive aspect are to be regarded as advantageous configurations of the respectively other inventive aspects.

A first aspect of the invention relates to a method for producing a blank for a packaging item, which includes a cellulose-containing base material with at least one line from the group of the folding, crease, cutting, scored and/or bending lines. According to the invention, a more flexible and reliable definition of one or more lines on the cellulose-containing base material is achieved by applying water and/or at least one hygroscopic substance to the base material at least in sections. In contrast to the prior art, in simplest configuration of the invention, it is thereby not required to define or produce the line by a stamping, cutting, grooving or other step resulting in material removal or in mechanical deformation of the base material. Instead, the at least one line is defined with the aid of water and/or a hygroscopic substance, which thus is or are preferably applied exclusively along the desired line without wetting or coating areas of the base material adjoining to the line. Within the scope of the present invention, a material is understood by a cellulose-containing base material, which is at least predominantly, that is with at least 51%, in particular at least 75% and preferably at least 90%, composed of cellulose, wherein percentage indications are basically to be understood as percent by weight within the scope of the present invention unless indicated to the contrary. Basically, the base material can be uncoated or be already provided with one or more layers on one side. For example, the base material can be coated or uncoated paper, coated or uncoated cardboard or coated or uncoated paperboard. Within the scope of the present invention, individual substances or substance mixtures are generally understood by a hygroscopic substance, which absorb water at least under SATP conditions (“Standard Ambient Temperature and Pressure”, standard temperature T=298.15 K corresponding to 25° C., standard pressure p=1013 hPa=1.013 bar) and are compatible with the cellulose-containing base material, that is do not damage it upon contact in undue manner. A typical characteristic of hygroscopic substances is for example the absorption of humidity (water vapor) from the atmosphere (air) surrounding them if the relative air humidity of the ambient atmosphere is >1%, in particular>20% and preferably between 35% and 100%. By the water and the hygroscopic substance, respectively, the base material can be specifically wetted and thereby softened or weakened in the area of the concerned line. With the aid of the line(s) defined according to the invention, specific material weakening of the base material limited to the defined line is allowed, whereby a simpler deflection, folding, separation and/or perforation of the base material are realizable such that packaging items can be faster and more reliably produced from such a blank. Moreover, the line(s) can be substantially more flexibly defined and adapted to different base materials and packaging item types since expensive machine processing of the base material for production of the line(s) is not required. For example, the application amount of the water and/or of the hygroscopic substance can be adapted to the layer thickness, the absorbency or the desired bending angle of the base material. In addition, the sorption isotherm and the hygroscopic point can be influenced via the amount and type of the applied substance.

Within the scope of this disclosure, “a/an” is generally to be read as an indefinite article, thus both as “only one” and “at least one” without explicitly opposite indication. For example, a blank produced according to the invention can only comprise a single line, which is defined in the manner described above. Alternatively, a blank produced according to the invention can comprise two or more lines, which are defined in the described manner. Similarly, it can be provided that a blank produced according to the invention includes one or more lines defined in the described manner and moreover one or more conventionally produced, thus for example stamped, creased, scored etc. lines. Furthermore, combinations of lines conventionally produced and defined according to the invention are basically possible, for example if a particularly great facilitation of the bending, folding or separation characteristics of the base material is requested. Similarly, it can be provided that a line is defined in sections in the manner described above and is conventionally defined or produced in other sections.

In an advantageous configuration of the invention, it is provided that at least one hygroscopic substance from the group of the hygroscopic solids, gels and/or liquids is applied to the base material. This allows optimally matching the hygroscopic substance to the concrete configuration of the base material and the packaging item to be produced. The aggregate states “solid” and “liquid” also relate to SATP conditions. Within the scope of the present invention, disperse systems are understood by a gel, which are composed of at least two components. Therein, the solid component constitutes a spongy, three-dimensional network, the pores of which are filled with a liquid (lyogel) or a gas (xerogel, aerogel). Examples for suitable substances include organic polymers, silicagel, zeolites, gelatin, glycerin as well as aqueous saline solution, for example of lithium chloride, lithium bromide, magnesium chloride, calcium chloride or sodium sulfate. Solid and gel-like substances have the advantage with respect to liquids that they do not or only very slowly blend after coating the base material, which can facilitate subsequent processing steps in some cases. Conversely, liquids can be very simply applied and are particularly well suitable for impregnating the base material to impart varying characteristics to it along the line. Preferably, the used hygroscopic substance is food-compatible. Furthermore, it can be provided that the hygroscopic substance is present dissolved in a solvent or suspended or dispersed in a suspending or dispersing agent.

Further advantages arise if at least one inorganic or organic salt, in particular an anhydrous inorganic or organic salt, is used as the hygroscopic substance. This allows particularly simple and inexpensive definition of the desired line(s). In particular, regenerative hygroscopic compounds with chloride, sulfate and/or phosphate ions such as for instance NaCl, MgCl₂ (E 511), Na₂SO₄ or K₂HPO₄/KH₂PO₄, which can be recovered, dried and reused after the use, are suitable as the inorganic salts.

In a further advantageous configuration of the invention, it is provided that the base material is bonded to at least one further material to a composite material. Hereby, the characteristics of the blank can be optimally adapted to the requirement profile of the subsequent packaging item. For example, plastics like acrylates, PE, PP, PVOH or PET, aluminum or also further cellulose-containing materials like paper, cardboard or paperboard, are suitable as the further material.

Depending on the further material, it has proven advantageous in some configurations of the invention if the base material is bonded to the further material via an adhesion agent. In other words, the base material and the further material are firmly bonded to each other via the adhesion agent to achieve a particularly reliable and highly durable material compound.

In a further advantageous configuration of the invention, it is provided that the water and/or the at least one hygroscopic substance are applied to the base material by at least one printing method, in particular from the group of contactless, direct and/or indirect printing methods, ink jet printing, flexographic printing, transfer printing, screen printing, offset printing, gravure printing, relief printing, planographic printing and digital printing, and/or by an application nozzle. This allows a particularly precise and flexible definition of the concerned line(s). The use of contactless printing methods allows a particularly fast and flexible definition of lines without mechanical deformation of the base material. Conversely, deformation of the base material, for example scoring or stamping, can be performed at the same time with the aid of contacting printing methods. Similarly, the base material can be cut or separated at the same time with the application.

Further advantages arise in that the base material is impregnated with the water and/or the hygroscopic substance at least in sections. Therein, a soaking treatment of the base material with the water and/or the hygroscopic substance is understood by impregnation. Hereby, the base material can be specifically equipped with varied material and use characteristics in the area of the concerned line.

Further advantages arise if the water and/or the at least one hygroscopic substance are applied to the base material in an amount between 1.0*10⁻¹² g/cm² and 5.0 g/cm². In other words, in some embodiments, it can be sufficient to apply the water and/or the hygroscopic substance in picogram, nanogram, microgram, milligram or centigram amounts as well as in amounts of 0.1 g, 0.2 g, 0.3 g, 0.4 g, 0.5 g, 0.6 g, 0.7 g, 0.8 g, 0.9 g, 1.0 g, 1.1 g, 1.2 g, 1.3 g, 1.4 g, 1.5 g, 1.6 g, 1.7 g, 1.8 g, 1.9 g, 2.0 g, 2.1 g, 2.2 g, 2.3 g, 2.4 g, 2.5 g, 2.6 g, 2.7 g, 2.8 g, 2.9 g, 3.0 g, 3.1 g, 3.2 g, 3.3 g, 3.4 g, 3.5 g, 3.6 g, 3.7 g, 3.8 g, 3.9 g, 4.0 g, 4.1 g, 4.2 g, 4.3 g, 4.4 g, 4.5 g, 4.6 g, 4.7 g, 4.8 g, 4.9 g or 5.0 g per square centimeter of base material, wherein all of the intermediate values are to be regarded as also disclosed. For example, in some configurations, it can be sufficient to apply the hygroscopic substance or a solution or dispersion thereof to the base material in picoliters with the aid of an ink jet printing method. In this manner, 1 ml of the hygroscopic substance or 1 ml of a solution/suspension/dispersion of a hygroscopic substance is for example sufficient for definition of one or more lines with a total length of above 300 m. Generally, the amount of humidity capable of being introduced into the base material can be increased with increasing amount of hygroscopic substance per area. Alternatively or additionally, it is provided that the water and/or the at least one hygroscopic substance are applied to the base material with a width between 0.1 mm and 50 mm, thus for example with a width of 0.1 mm, 0.2 mm, 0.3 mm, 0.4 mm, 0.5 mm, 0.6 mm, 0.7 mm, 0.8 mm, 0.9 mm, 1.0 mm, 1.1 mm, 1.2 mm, 1.3 mm, 1.4 mm, 1.5 mm, 1.6 mm, 1.7 mm, 1.8 mm, 1.9 mm, 2 mm, 3 mm, 4 mm, 5 mm, 6 mm, 7 mm, 8 mm, 9 mm, 10 mm, 11 mm, 12 mm, 13 mm, 14 mm, 15 mm, 16 mm, 17 mm, 18 mm, 19 mm, 20 mm, 21 mm, 22 mm, 23 mm, 24 mm, 25 mm, 26 mm, 27 mm, 28 mm, 29 mm, 30 mm, 31 mm, 32 mm, 33 mm, 34 mm, 35 mm, 36 mm, 37 mm, 38 mm, 39 mm, 40 mm, 41 mm, 42 mm, 43 mm, 44 mm, 45 mm, 46 mm, 47 mm, 48 mm, 49 mm or 50 mm, wherein all of the intermediate values are to be regarded as also disclosed. Hereby, it is possible to define differently wide lines, for example to define different bending angles, stampings, folds, scores, cuts or combinations hereof.

In a further advantageous configuration of the invention, it is provided that multiple lines are defined by applying the water and/or the at least one hygroscopic substance to the base material at least in sections. Hereby, for example folds with large radius as well as bent and complex folds, respectively, and cuts can be particularly simply and flexibly realized.

Further advantages arise in that the water and/or the at least one hygroscopic substance are applied to the base material such that at least one continuous or interrupted line and/or multiple lines arranged next to each other and/or at least one straight or curved line and/or a cutting line and at least one further line are defined. Hereby, the concerned line can be optimally adapted to the working step provided in producing a packaging item, thus for example to a folding, bending, cutting or separating step. Furthermore, it is possible to define a bending or stamping line and a cutting line without distance from each other, whereby the development of breaking or distortion edges can be reliably prevented.

In a further advantageous configuration of the invention, it is provided that the water and/or the hygroscopic substance are applied to a rear side of the base material and/or only in areas of the base material, which are reshaped and/or separated in the production of a packaging item from the blank. Hereby, it is ensured that areas of the base material adjoining to the concerned line(s) are not affected. Thereby, the base material retains its mechanical and optical characteristics in particular on its front side and in subsequent wall areas, respectively. Alternatively or additionally, it is provided that the water and/or the hygroscopic substance are applied over a mechanical deformation in the base material. Hereby, a corresponding line can be very precisely defined despite of an already present stamping or another mechanical deformation in the base material.

In further configuration of the invention, the blank is dried after applying the at least one hygroscopic substance. Hereby, blocking or blending of the hygroscopic substance as well as premature bending of the base material along the line are reliably prevented such that the blank can be stacked, rolled up, transported and stored without problem before its further processing to a packaging item.

A second aspect of the invention relates to a blank for producing a packaging item, which includes a cellulose-containing base material with at least one line from the group of the folding, crease, cutting, scored and/or bending lines. According to the invention, the at least one line is defined by water and/or at least one hygroscopic substance applied to the base material at least in sections. With the aid of the line(s) defined according to the invention, specific material weakening of the base material is allowed, which allows simpler bending, folding, separation and/or perforation of the base material such that packaging items can be faster and more reliably produced from such a blank. Moreover, the line(s) can be substantially more flexibly defined and adapted to different base materials and packaging item types since expensive machine processing of the base material for producing the line(s) is not required. For example, the application amount of the water and/or the hygroscopic substance can be adapted to the layer thickness, the absorbency or the desired bending angle of the base material. Further features and the advantages thereof can be taken from the descriptions of the first inventive aspect, wherein advantageous configurations of the first inventive aspect are to be regarded as advantageous configurations of the second inventive aspect and vice versa.

In an advantageous configuration of the invention, it is provided that the at least one line is defined between at least two elements from the group of adhesive flap, rear wall element, sidewall element, front wall element, lid wall element, bottom wall element, insertion flap, lid flap, dust flap and bottom flap. This allows particularly flexible adaptation of the blank to very different packaging item types.

A third aspect of the invention relates to a method for producing a packaging item from a blank, which is produced by a method according to the first inventive aspect and/or formed according to the second inventive aspect, in which the at least one line, which is defined by water and/or by the hygroscopic substance applied to the base material at least in sections, is folded and/or cut and/or scored and/or bent. Hereby, different packaging item types can be particularly simply and reliably produced since the line(s) can be particularly flexibly defined and the correspondingly equipped blank can be correspondingly simply and precisely processed to the respective packaging item. Further features and the advantages thereof can be taken from the descriptions of the first and second inventive aspects, wherein advantageous configurations of the first and second inventive aspects are to be regarded as advantageous configurations of the third inventive aspect and vice versa.

In an advantageous configuration of the invention, the hygroscopic substance is wetted before the folding, creasing, cutting, scoring and/or bending step. Hereby, humidity is transported to or into the cellulose-containing base material via the hygroscopic substance in the area of the concerned line, whereby it can be easier bent, folded, scored or separated along the line. This is in particular advantageous if the blank and the hygroscopic substance, respectively, have been dried before processing to the packaging item to improve the storage, stacking and transport capability of the blank.

Further advantages arise by wetting the hygroscopic substance by adjusting the ambient air humidity and/or by applying water. This presents a particularly fast and simple possibility of providing humidity in the area of the line to be processed.

By removing the hygroscopic substance at least predominantly from the base material after the folding, creasing, cutting, scoring and/or bending step in further configuration, the packaging item can be further processed or filled without this substance on the one hand to avoid contamination of the goods to be packaged, the hygroscopic substance can be collected, optionally regenerated and used for a further process passage on the other hand, whereby corresponding ecological and economical advantages are achieved.

A fourth aspect of the invention relates to a packaging item for storing goods, in particular cereals and/or rod-shaped goods like cigarettes and the like, wherein the packaging item is at least partially made from a blank produced by a method according to the first inventive aspect and/or formed according to the second inventive aspect and/or obtainable and/or obtained by means of a method according to the third inventive aspect. The features and advantages thereof resulting from it can be taken from the descriptions of the first, second and third inventive aspects, wherein advantageous configurations of the first, second and third inventive aspects are to be regarded as advantageous configurations of the fourth inventive aspect and vice versa.

Further features of the invention are apparent from the claims, the figures and the description of figures. The features and feature combinations mentioned above in the description as well as the features and feature combinations mentioned below in the description of figures and/or shown in the figures alone are usable not only in the respectively specified combination, but also in other combinations without departing from the scope of the invention. Thus, implementations are also to be considered as encompassed and disclosed by the invention, which are not explicitly shown in the figures and explained, but arise from and can be generated by separated feature combinations from the explained implementations. Implementations and feature combinations are also to be considered as disclosed, which thus do not comprise all of the features of an originally formulated independent claim. Moreover, implementations and feature combinations are to be considered as disclosed, in particular by the implementations set out above, which extend beyond or deviate from the feature combinations set out in the relations of the claims. There shows:

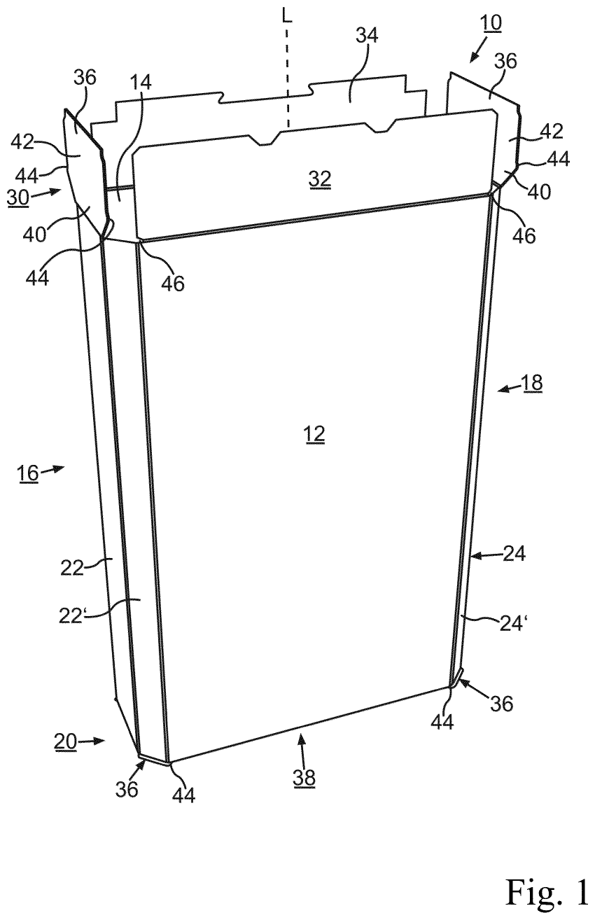

FIG. 1 a schematic representation of a packaging item according to the invention;

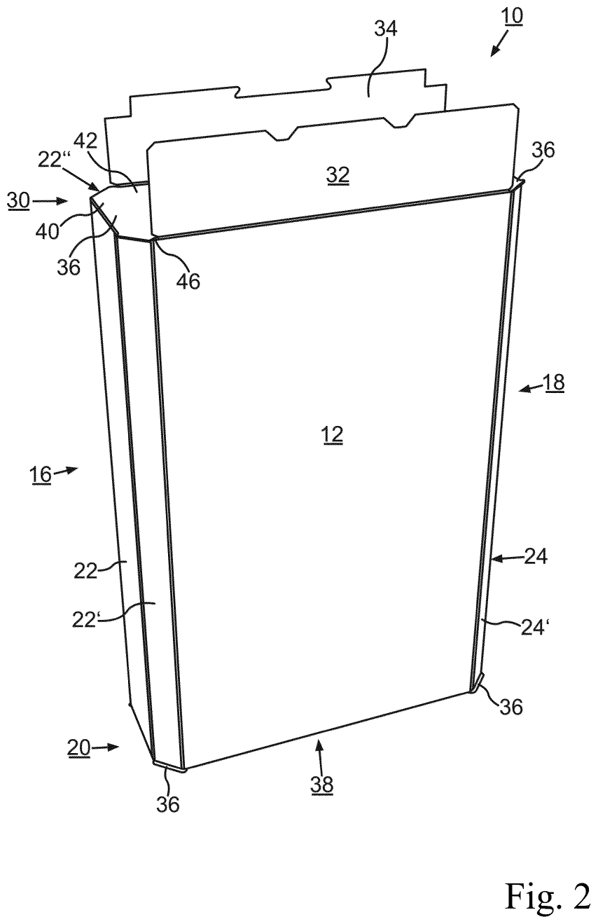

FIG. 2 a schematic representation of the packaging item according to FIG. 1 in partially closed state;

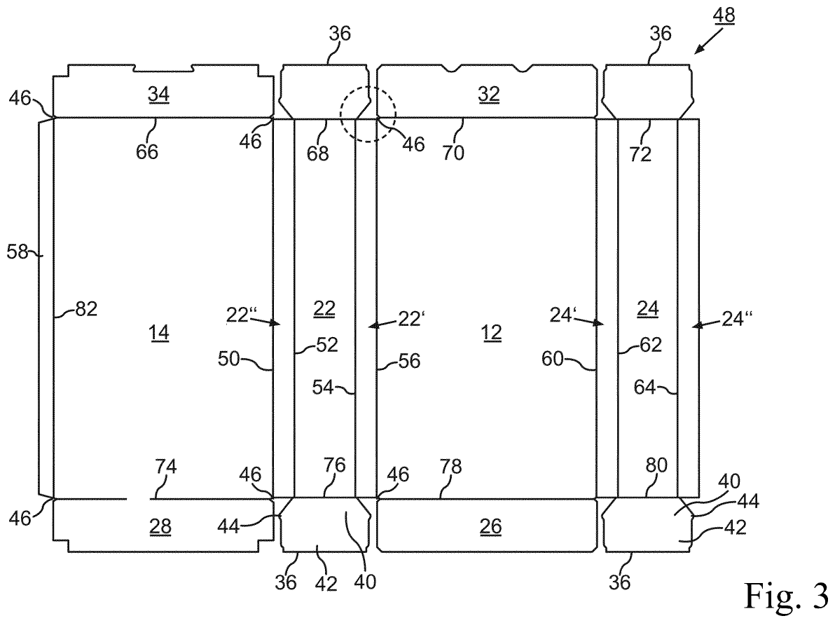

FIG. 3 a schematic representation of a blank of the packaging item according to the invention according to FIG. 1;

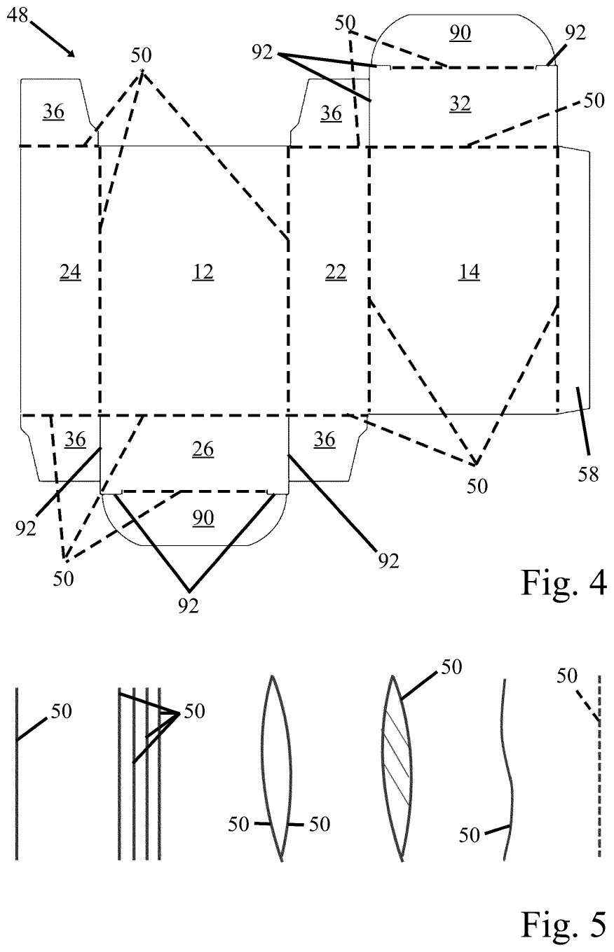

FIG. 4 a schematic representation of a blank according to the invention according to a further embodiment; and

FIG. 5 a schematic diagram with examples of differently formed lines.

FIG. 1 shows a schematic representation of a packaging item 10 according to the invention, which in particular serves for the storage and the transport of pourable, powdery and free-flowing foods, for example cereals. The packaging item 10 is composed of cardboard and therein comprises a front wall 12 and a rear wall 14, which are connected via respectively three sidewalls 22, 22′, 22″, 24, 24′, 24″ (see also FIGS. 2 and 3). The sidewalls 22, 22′, 22″, 24, 24′, 24″ constitute the end sides 16, 18 of the packaging item 10. One recognizes that the packaging item 10 is formed in the shape of a prismatic body along a longitudinal axis L and has an octagonal base surface 38. In addition, the packaging item 10 comprises a bottom construction 20, which comprises each one bottom flap 26, 28 hinged to the front and rear walls 12, 14 for bottom-side closure of the packaging item 10 (see also FIG. 3). Furthermore, the packaging item 10 comprises a lid construction 30, wherein the lid construction 30 includes each one lid flap 32, 34 hinged to the front and rear walls 12, 14 for lid-side closure of the packaging item 10. In addition, in the illustrated embodiment, both the bottom construction 20 and the lid construction 30 each comprise dust flaps 36 (compare also FIG. 3) hinged to the bottom-side and lid-side ends of the end-side sidewalls 22, 24. One recognizes that the dust flaps 36 are hinged to the central one of the three sidewalls 22, 24 forming the end sides 16, 18.

Furthermore, one recognizes that the dust flaps 36 each include a first section 40, wherein the first section 40 is hinged to the corresponding end-side sidewall 22, 24. A second section 42 adjoins to the first section 40, wherein lateral locking lugs 44 are respectively arranged in the transitional area between the first section 40 and the second section 42. The locking lugs 44 are formed such that they can lock in the recesses 46 formed in the bottom and lid flaps 26, 28, 32, 34 in a closure position of the dust flap 36 (compare also FIG. 2). Therein, the recesses 46 are respectively formed in the transitional area between the front and rear walls 12, 14 and the corresponding bottom and lid flaps 26, 28, 32, 34.

FIG. 2 shows the packaging item 10 with a closure position of the dust flaps 36 of the lid construction 30. One recognizes that the dust flaps 36 are formed such that they rest on the sidewalls 22′, 22″, 24′, 24″ in the closure position. The dust flap 36 is not hinged to the sidewalls 22′, 22″, 24′, 24″. Furthermore, it becomes clear that the dust flaps 36 protrude beyond the mentioned sidewalls 22′, 22″, 24′, 24″ in their closure position and thus overall cover the area of the base surface 38 formed by the sidewalls 22, 22′, 22″, 24, 24′, 24″ arranged on the end side of the packaging item 10 formed as a prismatic body. Thereby, secure closure and secure overlap, respectively, of this area of the packaging item 10 are ensured on the one hand. On the other hand, the loading stability of the packaging item 10 in this area considerably increases. The dust flaps 36 of the bottom construction 20 are identically formed.

In addition, it becomes clear that the locking lugs 44 abut on the bottom and lid flaps 26, 28, 32, 34 in the closure position of the dust flap 36 and lock in the corresponding recesses 46.

One additionally recognizes that the second section 42 of the dust flaps 36 is respectively formed such that it abuts on the inner sides of the front and rear walls 12, 14 in closure position of the dust flaps 36. By this support of the inner sides of the front and rear walls 12, 14, considerable increase of the shape stability of the packaging item 10 results.

FIG. 3 shows a schematic representation of a blank 48 of the packaging item 10 according to FIG. 1. The blank 48 includes front wall, rear wall and sidewall elements 12, 14, 22, 22′, 22″, 24, 24′, 24″ connected via lines 50, 52, 54, 56, 60, 62, 64 presently formed as bending lines for forming the packaging item 10 as a prismatic shape body in the folded state of the blank 48 (see FIGS. 1 and 2). One recognizes that the blank 48 comprises two lid and bottom flaps 32, 34, 26, 28 hinged to the front and rear wall elements 12, 14. A dust flap 36 is respectively hinged to the respective ends of the sidewalls 22, 24 via bending lines 68, 72, 76, 80. The lid and bottom flaps 32, 34, 26, 28 are connected to the corresponding front and rear wall elements 12, 14 via corresponding bending lines 66, 70, 74, 78. The blank 48 comprises an adhesive flap 58 at the end opposing the sidewall element 22″, which is connected to the rear wall element 14 via a bending line 82.

Furthermore, one recognizes that a recess 46 is respectively formed in the transitional area between the front and rear wall elements 12, 14 and the corresponding bottom and lid flaps 26, 28, 32, 34.

The dust flap 36 is formed such that it rests on the sidewall elements 22′, 22″, 24′, 24″, to which it is not hinged, in folded state of the blank 48 and in a closure position (compare also FIG. 2). In particular, the dust flap 36 protrudes beyond the sidewall elements 22′, 22″, 24′, 24″, on which it rests, in folded state of the blank 48 and in a closure position. One recognizes that the dust flaps 36 are respectively composed of a first section 40 and a second section 42 adjoining thereto. The first section 40 is hinged to the corresponding ends of the sidewall elements 22, 24. In addition, the first section 40 is formed such that it covers the area of a base surface 38 of the packaging item 10 formed by the sidewall elements 22, 22′, 22″, 24, 24′, 24″ arranged on the end side in folded state of the blank 48 and in closure position of the dust flap 36. The second section 42 is formed such that it abuts on the inner sides of the front and rear wall elements 12, 14 in folded state of the blank 48 and in closure position of the dust flap 36. Furthermore, one recognizes that a locking lug 44 is respectively laterally formed in the dust flap 36 in the transition between the first section 40 and the second section 42. In the illustrated embodiment, the first section 40 is approximately trapezoidally formed, the second section 42 is rectangularly formed.

The lines 50, 52, 54, 56, 60, 62, 64, 66, 68, 70, 72, 74, 76, 78, 80 and 82 are respectively defined by water and/or a hygroscopic substance, for example MgCl₂, applied to the rear side of the blank 48 to ensure better bendability and foldability of the cardboard. Therefore, so-called debossing or embossing as well as additional mechanical processings of the lines 50, 52, 54, 56, 60, 62, 64, 66, 68, 70, 72, 74, 76, 78, 80 and 82 are not required and can basically be omitted. The application of water and/or one or more hygroscopic substances to the surface of the cardboard can be effected by transfer, imprinting, spraying via nozzles or mechanical and/or digital transfer if necessary, wherein the cardboard or blank 48 can also be impregnated if necessary.

In case of an airing substance or if a dry, that is water-free or anhydrous, hygroscopic substance is applied for definition of one or more lines 50, 52, 54, 56, 60, 62, 64, 66, 68, 70, 72, 74, 76, 78, 80 and 82, the humidity absorption and the transfer of the humidity into the cardboard, respectively, can be effected only shortly before the production of the packaging item 10 by applying water to the hygroscopic substance and/or by adjusting the air humidity of the ambient air to a sufficiently high value in order that the hygroscopic substance can absorb the desired amount of humidity. For example, this can be effected in an air-conditioned room.

FIG. 4 shows a schematic representation of a blank 48 according to the invention according to a further embodiment. The blank 48 includes a sidewall 24, which is connected to two dust flaps 36 via respective lines 50 formed as bending lines. The sidewall is connected to a rear wall 12 via a further line 50. The rear wall 12 is in turn connected to a bottom flap 26 via a line 50, which is connected to an insertion flap 90 via a further line 50 and two lines 92 formed as cutting lines. Lines 92 formed as cutting lines are located between the bottom flap and the laterally adjoining dust flaps 36. Furthermore, the rear wall 12 is connected to a sidewall 22 via a bending line 50, which in turn is connected to two dust flaps 36 via lines 50. The sidewall 22 is connected to a front wall 14 via a further bending line 50, which is connected to an adhesive flap 58 via a line 50. Furthermore, the front wall 14 is connected to a lid flap 32 via a line 50. The lid flap 32 is connected to the dust flap 36 via a cutting line 92 and to an insertion flap 90 via two cutting lines 92 and a bending line 50.

The dashed drawn bending lines 50 are again defined exclusively by applying water and/or a hygroscopic substance like MgCl₂, while the cutting lines 92 are punched. Alternatively, it can also be provided that the cutting lines 92 are also defined by applying water and/or a hygroscopic substance to facilitate separation of the blank 48 in these sections.

The embodiments of the packaging items 10 and the blanks 48, respectively, described in the preceding figures serve for clarifying the basic principle of the present invention. In particular, a plurality of differently formed packaging items 10 and blanks 48 is conceivable. Thus, the base surfaces 38 of the packaging item 10 formed as a prismatic body can not only be octaognally, but also triangularly, quadrangularly, pentagonally, hexagonally, decagonally or dodecagonally formed. Other shapes are also possible.

The preceding described packaging items 10 are formed as folding boxes. Like the associated blanks 48, they are in particular composed of cardboard, paper or comparable cellulose-containing materials. However, composite materials of a cellulose-containing base material and one or more other materials can basically also be provided, for example paper+PET, cardboard+PET, aluminum+cardboard, PE+aluminum+cardboard, PVOH+paperboard etc. with or without adhesion agent between the individual layers. For definition of one or more lines 50, 52, 54, 56, 60, 62, 64, 66, 68, 70, 72, 74, 76, 78, 80, 82 and 92, water and/or a hygroscopic substance are preferably applied to one side of a paper, cardboard and/or paperboard layer, which subsequently is to constitute an inner side of the packaging item 10. Furthermore, it can be provided that after folding the blank 48 and after completion of the corresponding packaging item 10, respectively, the hygroscopic substance is removed from it and optionally regenerated and reused.

FIG. 5 shows a schematic diagram with examples of differently formed lines, which are all provided with the reference character 50 for the sake of simplicity. However, it is to be emphasized that the lines 50 can basically be identically or differently defined. For example, multiple lines 50 can be defined by applying different hygroscopic substances or substance mixtures. Furthermore, multiple lines 50 can satisfy different functions in producing a packaging item 10 from a correspondingly equipped blank 48 and be formed or used independently of each other as folding, crease, cutting, scored and/or bending lines.

Multiple lines 50 can for example be defined next to each other by application of water and/or a hygroscopic substance to allow folds with larger radii. Arched, flat, curved, interrupted and generally complexly formed lines 50 can also be defined by applying water and/or a hygroscopic substance in fast, simple and flexible manner without further mechanical processing steps of the base material being required in this respect.

The parameter values indicated in the documents for the definition of process and measurement conditions for the characterization of specific characteristics of the inventive subject matter are to be considered as encompassed by the scope of the invention also within the scope of deviations—for example due to measurement errors, system errors, weighing errors, DIN tolerances and the like.

1. A method for producing a blank for a packaging item, comprising:
a base material containing cellulose with at least one line from the group of folding, crease, cutting, scored and/or bending lines, wherein the at least one line is defined by applying water and/or at least one hygroscopic substance to the base material at least in sections.

2. The method according to claim 1, wherein the at least one hygroscopic substance is from the group of hygroscopic solids, gels and/or liquids and is applied to the base material.

3. The method according to claim 2, wherein at least one inorganic or organic salt, in particular an anhydrous inorganic or organic salt, is used as the at least one hygroscopic substance.

4. The method according to claim 1, wherein the base material is bonded to at least one further material to a composite material.

5. The method according to claim 4, wherein the base material is bonded to the at least one further material via an adhesion agent.

6. The method according to claim 1, wherein the water and/or the at least one hygroscopic substance are applied to the base material by at least one printing method, in particular from the group of contactless, direct and/or indirect printing methods, ink jet printing, flexographic printing, transfer printing, screen printing, offset printing, gravure printing, relief printing, planographic printing and digital printing, and/or by an application nozzle.

7. The method according to claim 1, wherein the base material is impregnated with the water and/or the at least one hygroscopic substance at least in sections.

8. The method according to claim 1, wherein the water and/or the at least one hygroscopic substance are applied to the base material in an amount between 1.0*10⁻¹² g/cm² and 5.0 g/cm² and/or with a width between 0.1 mm and 50 mm.

9. The method according to claim 1, wherein multiple lines are defined by applying the water and/or the at least one hygroscopic substance to the base material at least in sections.

10. The method according to claim 1, wherein the water and/or the at least one hygroscopic substance are applied to the base material such that at least one continuous or interrupted line and/or multiple lines arranged next to each other and/or at least one straight or curved line and/or a cutting line and at least one further line are defined.

11. The method according to claim 1, wherein the water and/or the at least one hygroscopic substance are applied to a rear side of the base material and/or over a mechanical deformation in the base material and/or only in areas of the base material, which are reshaped and/or separated in the production of the packaging item from the blank.

12. The method according to claim 1, wherein the blank is dried after applying the at least one hygroscopic substance.

13. A blank for producing a packaging item comprising:
a base material containing cellulose with at least one line from the group of folding, crease, cutting, scored and/or bending lines, wherein the at least one line is defined by water and/or by at least one hygroscopic substance applied to the base material at least in sections.

14. The blank according to claim 13, wherein the at least one line is defined between at least two elements from the group of an adhesive flap, a rear wall element, a sidewall element, a front wall element, a lid wall element, a bottom wall element, an insertion flap, a lid flap, a dust flap and a bottom flap.

15. A method for producing a packaging item from a blank, which is formed according to claim 13, in which the at least one line, which is defined by water and/or by the at least one hygroscopic substance applied to the base material at least in sections, is folded and/or creased and/or cut and/or scored and/or bent.

16. The method according to claim 15, wherein the at least one hygroscopic substance is wetted before the folding, creasing, cutting, scoring and/or bending step.

17. The method according to claim 16, wherein the at least one hygroscopic substance is wetted by adjusting ambient air humidity and/or by applying water.

18. The method according to claim 15, wherein the at least one hygroscopic substance is at least predominantly removed from the base material after the folding, creasing, cutting, scoring and/or bending step.

19. A packaging item for storing goods, in particular cereals and/or rod-shaped goods like cigarettes and the like, wherein the packaging item is at least partially formed from a blank, which is produced by a method according to claim 1.

20. A packaging item for storing goods, in particular cereals and/or rod-shaped goods like cigarettes and the like, wherein the packaging item is at least partially formed from a blank, which is produced by a method according to claim 15.
